(19) United States
(12) Patent Application Publication
(10) Pub. No.: US 2021/0352469 A1
(43) Pub. Date: Nov. 11, 2021

(54) USER PLANE SECURITY

(71) Applicant: Telefonaktiebolaget LM Ericsson (publ), Stockholm (SE)

(72) Inventor: Noamen BEN HENDA, VÄLLINGBY (SE)

(21) Appl. No.: 17/268,595

(22) PCT Filed: Aug. 20, 2018
(86) PCT No.: PCT/EP2018/072420

§ 371 Date: Feb. 15, 2021

(51) Int. Cl. H04W 12/033; H04W 12/106; H04L 29/06; H04W 12/06

(52) U.S. Cl. CPC H04W 12/033; H04W 12/06; H04L 63/205; H04W 12/106

(57) ABSTRACT

Embodiments presented herein relates to a method for user plane security in a wireless communication system. The method is performed in a core network (CN) node 3 and comprises receiving a first message from a wireless terminal (WT), the first message including an indication that the WT 1 supports an additional security layer, sending a second message to the WT in response to the received first message, the second message including an indication that the CN supports the additional security layer, and sending a third message to a separate CN node, the third message comprising an indication that the additional security layer is to be used in communication with the WT. A method, CN nodes, WTs, computer programs, and a computer program product for user plane security in a wireless communication system are also presented.

### TECHNICAL FIELD

The invention relates to methods, core network nodes, wireless terminals, computer programs and a computer program product for user plane security in a wireless communication system.

### BACKGROUND

The architecture for the 4^{th} Generation Mobile Communication System, a.k.a. Long Term Evolution (LTE), is described in the 3^{rd} generation partnership project (3GPP) technical specification (TS) 23.401. FIG. 2 shows, the non-roaming reference architecture of evolved packet system (EPS) illustrated in FIG. 40.2.1-1 therein.

The security architecture for LTE is described in 3GPP TS 33.401. One of the most important goals of the security work in 3GPP is to protect the communication over the air interface LTE-Uu between the User Equipment (UE) and the Evolved Terrestrial Radio Access Network (E-UTRAN) which is the Access Network (AN). Therefore, LTE was designed so that all signalling could be integrity and confidentiality protected, while user data only confidentiality protected. In order to describe the security mechanisms, it is important to give insights on the different communicating channels between the UE and the network.

There are two levels of communications between the UE and the network. The first one is between the UE and the Mobility Management Entity (MME) in the Core Network (CN). This is only used for signalling and is over the Non-Access Stratum (NAS) protocol. The second level is between the UE and the evolved NodeB (eNB) in the E-UTRAN. This is used for both signalling and user data transport. The signalling is over the Radio Resource Control (RRC) protocol. RRC is transported over another protocol called Packet Data Convergence Protocol (PDCP). Meanwhile the user data is directly transported over the PDCP protocol.

In order to activate the security protection at the PDCP and NAS level, key establishment and selection of security algorithms need to take place. Key establishment is realized by the authentication procedure Authentication and Key Agreement (AKA) which results in a shared key called KASME between the UE and the MME in the serving network. This key is then used as the root key for the derivation of all subsequent keys such as for the NAS protocol protection and further keys for AS security. The selection of the algorithms is realized via Security Mode (SM) Command procedures. There are separate procedures for NAS and AS, namely, one NAS SM command procedure and one AS SM command procedure.

As described in 3GPP TS 33.401, the NAS SM command procedure is a round trip of NAS messages used to agree on the security algorithms to be used and also to activate the integrity and confidentiality protection for the NAS protocol. The AS SM command achieves the same goal but for the RRC protocol and the User Plane (UP).

### SUMMARY

An object presented herein is how to enable core network terminated user plane security without breaking backward compatibility.

According to a first aspect there is presented a method for user plane security in a wireless communication system. The method is performed in a core network (CN) node and comprises receiving a first message from a wireless terminal (WT), the first message including an indication that the WT supports an additional security layer, sending a second message to the WT in response to the received first message, the second message including an indication that the CN supports the additional security layer, and sending a third message to a separate CN node, the third message comprising an indication that the additional security layer is to be used in communication with the WT.

By the presented method, CN terminated UP security is achieved in a wireless communication system, without breaking backward compatibility.

The method may further comprise determining that the received additional security layer is supported by the CN.

The first message may be an initial attach message, the second message, may be a non-access (NAS) security mode command message, and the third message may be a create session request message.

The indication in the first message may be signalled by a spare bit in a security capability information element (IE).

The CN node may be a mobility management entity (MME), and the separate CN node may be a serving gateway (S-GW).

According to a second aspect there is presented a method for user plane security in a wireless communication system. The method is performed in a WT and comprises sending a first message to a CN node, the first message including an indication that the WT supports an additional security layer, receiving a second message from the CN node in response to the send first message, the second message including an indication that the CN supports the additional security layer, and determining an integrity protection key in response to the received second message, for use of the additional security layer in communication with a separate CN node. The method may further comprise sending a third message to the CN node in response to the received second message, the third message being a NAS security mode complete message. The first message may be an initial attach message, and the second message may be a NAS security mode command message.

The indication in the first message may be signalled by a spare bit in a security capability IE.

The CN node may be an MME, and the separate CN node may be an S-GW.

According to a third aspect there is presented a CN node for user plane security in a wireless communication system. The CN node comprises a processing circuitry and a computer program product storing instructions that, when executed by the processing circuitry, causes the CN node to receive a first message from a WT, the first message including an indication that the WT supports an additional security layer, to send a second message to the WT in response to the received first message, the second message including an indication that the CN supports the additional security layer, and to send a third message to a separate CN node, the third message comprising an indication that the additional security layer is to be used in communication with the WT.

The CN node may further be caused to determine that the received additional security layer is supported by the CN.

According to a fourth aspect there is presented a WT for user plane security in a wireless communication system. The WT comprises a processing circuitry and a computer program product storing instructions that, when executed by the processing circuitry, causes the WT to send a first message to a CN node, the first message including an indication that the WT supports an additional security layer, to receive a second message from the CN node in response to the send first message, the second message including an indication that the CN supports the additional security layer, and to determine an integrity protection key in response to the received second message, for use of the additional security layer in communication with a separate CN node.

The WT may further be caused to send a third message to the CN node in response to the received second message, the third message being a NAS security mode complete message.

According to a fifth aspect there is presented a CN node for user plane security in a wireless communication system. The CN node comprises a communication manager for receiving a first message from a WT, the first message including an indication that the WT supports an additional security layer, sending a second message to the WT in response to the received first message, the second message including an indication that the CN supports the additional security layer, and for sending a third message to a separate CN node, the third message comprising an indication that the additional security layer is to be used in communication with the WT.

According to a sixth aspect there is presented a WT for user plane security in a wireless communication system. The WT comprises a communication manager for receiving a first message from a WT, the first message including an indication that the WT supports an additional security layer, sending a second message to the WT in response to the received first message, the second message including an indication that the CN supports the additional security layer, and for sending a third message to a separate CN node, the third message comprising an indication that the additional security layer is to be used in communication with the WT.

According to a seventh aspect there is presented a computer program for user plane security in a wireless communication system. The computer program comprises computer program code which, when run in a CN node, causes the CN node to, receive a first message from a WT, the first message including an indication that the WT supports an additional security layer, to send a second message to the WT in response to the received first message, the second message including an indication that the CN supports the additional security layer, and to send a third message to a separate CN node, the third message comprising an indication that the additional security layer is to be used in communication with the WT.

According to an eighth aspect there is presented a computer program for user plane security in a wireless communication system. The computer program comprises computer program code which, when run in a WT, causes the WT to, send a first message to a CN node, the first message including an indication that the WT supports an additional security layer, receive a second message from the CN node in response to the send first message, the second message including an indication that the CN supports the additional security layer, and to determine an integrity protection key in response to the received second message, for use of the additional security layer in communication with a separate CN node.

According to a ninth aspect there is also presented a computer program product comprising a computer program and a computer readable storage means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment wherein embodiments presented herein can be applied;

FIG. 2 illustrates the non-roaming architecture for 3GPP access;

FIG. 3 illustrates core network terminated user plane integrity protection for embodiments presented herein,

FIG. 4 is a schematic diagram illustrating signalling for embodiments presented herein;

FIGS. 5-6 are flow charts illustrating methods for embodiments presented herein;

FIGS. 7-8 are schematic diagrams illustrating some components of devices presented herein;

FIGS. 9-10 are schematic diagrams illustrating functional module of devices presented herein.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

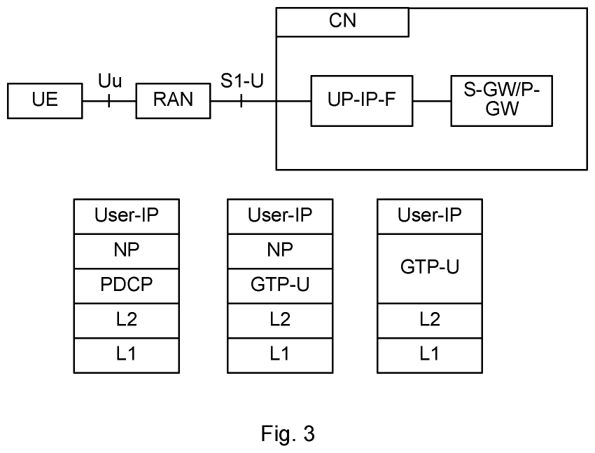

A discussion is ongoing for the 3^{rd} generation partnership project (3GPP) regarding the termination of the user plane (UP) security for new generations of mobile communication systems. In Universal Mobile Telecommunications System (UMTS), a.k.a. 3G, UP security is terminated in the core network (CN). In evolved packet system (EPS), a.k.a. 4G, UP security is terminated in the radio access network (RAN). It has for 5G been discussed whether UP security could be terminated in the RAN or the CN. The discussions have led to the termination in the RAN, like in 4G. The possibility to have an additional security layer for the UP terminated in the CN, as shown in FIG. 3, has been discussed for future releases. This is because such a feature does present benefits such as being handover-agnostic and also being used to realize end-to-end protection between the user equipment (UE) and a network slice.

For 4G, with mandatory support of integrity protection for the UP, this feature can minimize impact on the network deployments since it does not require RAN upgrades but rather the introduction of an additional network function (illustrated with UP-IP-F in FIG. 3) on the UP path between the RAN and the serving gateway (S-GW). Such a function may be integrated in the S-GW and in such case an upgrade would be required. However, from a deployment perspective, impact on S-GWs would be rather acceptable compared to impact on RAN due to the considerably larger number of RAN nodes in the field.

FIG. 3 illustrates CN terminated UP Integrity Protection. As is shown in FIG. 3, the additional network function, here called UP-IP-F, is illustrated as separate from the S-GW. The rightmost protocol stack illustrates a legacy stack. The leftmost protocol stack illustrates the new feature realized by an additional New Protocol (NP) on top of PDCP between the UE and the new terminating function, and the middle protocol stack illustrates the NP on top of the GTP-U between the RAN and the new terminating function.

There are two main issues for the introduction of the CN terminated UP security feature in 4G, and also in 5G. First, since 4G is widely deployed, backward compatibility issues arise. How would the network, if upgraded with such a feature, cope with different types of UEs, upgraded and legacy. UEs won't be upgraded simultaneously and some might even never be upgraded to support such a feature. The deployment of such feature will undergo some potentially long (in years) transition phase during which upgraded and legacy both networks and UEs coexist and interact with each other. If this feature is standardized to be optional, some networks might choose to never deploy it. Therefore, a mechanism is needed to enable a network and a UE to negotiate and agree on the support and use of this feature.

The second issue is related to the activation of the security for this new protocol layer NP between the UE and the CN. If the same pattern is applied as for access-stratum (AS) and non-AS (NAS) security activation, then a similar procedure would be required directly between the UE and the UP security termination function. One downside is that this will result in signalling over the UP path which defeats the principle of separation between UP and control plane (CP). In order to preserve this principle, an alternative is to run the security mode (SM) command procedure through the mobility management entity (MME). This is however unnecessarily complex and does not provide any additional security. Since the MME is in possession of the root key, it can as well perform the negotiation on behalf of the UP security termination function.

Negotiation and activation of the security for the CN terminated UP integrity protection may be achieved by the following steps.
An UE supporting CN terminated UP integrity protection includes an indication in an initial message (initial attach) to an MME to signal its support of the feature.
The MME in a CN supporting the feature includes a confirmation to the UE that the feature is supported by the network in a downlink message from the MME to the UE (NAS SM command).
The UE acts on the confirmation by activating the UP security layer terminated in the CN.
The MME acts on a received uplink completion message from the UE (NAS Security Mode Complete) to configure the UP security termination function accordingly.

The presented mechanism has the following advantages: It is backward compatible since it allows legacy and upgraded, both UEs and networks, to coexist and interact. It is secure against bidding down attacks since the signalling of the feature support is integrated in the NAS SM command procedure. It is light weight and does not require a new standalone procedure for activation of the security between the UE and the UP security termination function. It enables the CN terminated UP security concept not only for integrity but also for confidentiality protection.

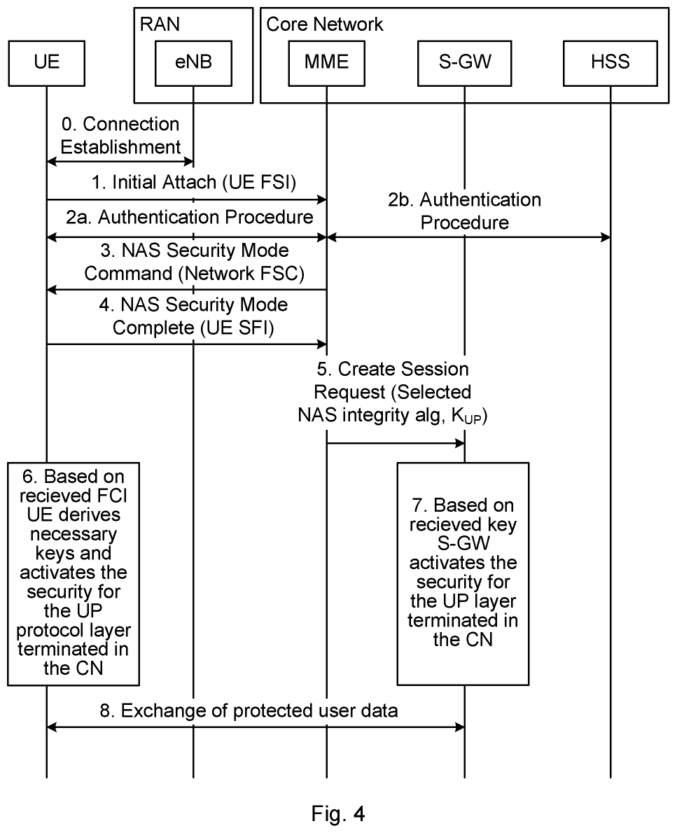

FIG. 4 illustrates the steps related to negotiation and activation of the security for CN terminated UP security according to an embodiment presented herein. The assumption here is that a new protocol NP layer on top of PDCP is used in order to integrity protect the UP traffic between the UE and the S-GW in the serving network. The detailed description of the steps is given below.

In an initiation step 0, the UE establishes a connection with the RAN node (eNB) of a wireless communication system.

The UE, in step 1, sends an initial attach message optionally including a new parameter, here called UE Feature Support Indication (FSI), in order to inform the CN that the UE supports the CN terminated UP integrity protection.

The MME, in response to the received initial attach, triggers the authentication procedure (AKA) in order to establish the anchor security key KASME between the UE and the MME, by communicating with the UE, step 2a, and with the home subscriber server (HSS), step 2b. More details on the AKA procedure can be found in TS 33.401.

The MME thereafter starts the NAS SM command procedure by, in step 3, sending a NAS Security Mode Command message to the UE including the key set identifier (eKSI), the selected NAS security algorithms and the replayed UE security capabilities. In addition, if the MME has received the UE FSI and the networks supports the feature then the MME optionally includes a new parameter, here called the network Feature Support Confirmation (FSC), indicating to the UE that the network supports the CN terminated UP integrity protection.

The UE, in step 4, thereafter replies with the NAS Security Mode Complete message. Further details on the NAS SM command procedure can be found in TS 33.401. In addition, if the UE has provided the FSI and the MME has provided the FSC, then the MME derives the necessary integrity protection key from the current key material (e.g. KASME) and, in step 5, includes it in the Create Session Request message to the S-GW together with the currently selected NAS integrity algorithms.

In step 6, when the UE receives the confirmation FSC back from the CN, then the UE derives the necessary integrity protection key from the current key (e.g. KASME) and activates the security for the protocol layer terminated in the CN and intended to carry the integrity protected user data.

In step 7, when the S-GW receives security parameters (e.g. key and security algorithms), in addition to other session parameters, the S-GW activates the security for the protocol layer terminated in the CN and intended to carry the integrity protected user data. The steps 6 and 7 are performed independent of each other and may be performed in either order, or in parallel.

The UE and network, in step 8, start exchanging protected user data.

In order to guarantee backward compatibility, the UE FSI may be signalled using one of the spare bits for algorithm support in the UE security capabilities Information Element (IE). For example, EIA7 may be a reasonable choice since it is very unlikely that 5 new integrity algorithms are introduced within the lifetime of LTE.

An upgraded UE will have this spare bit set, in its UE security capabilities. Consequently, the UE FSI is realized by the transmission of UE security capabilities that are included by default in the Initial Request message (step 1). An MME that is not supporting the indication does not act on any of the spare bits whenever they are set and simply replays the UE security capabilities in the integrity protected NAS SM Command message (step 3) as expected. An upgraded MME acts on the spare bit that is set and sends back the network FCI in a new IE. One advantage of this embodiment is that this additional UE FSI indication would benefit from the bidding down protection provided to the UE security capabilities. The biding down protection is realized by replaying back the UE security capabilities, received in the initial attach message (step 1), in the integrity protected NAS SM command message in step 3.

Using the algorithm spare bit in this way is however for a different purpose than that it was initially intended to. Another alternative is to use a separate new IE to signal the UE FSI parameter. Then the UE would first try to send the UE FSI as depicted in step 1. For a legacy MME, the attach procedure would fail, and the reject cause would for example indicate a missing or unsupported IE as described in TS 24.301. In such a case, the UE reattempts the attach procedure without inclusion of this UE FSI IE.

This trial and error method may however add a delay to service access for upgraded UEs. This may be rectified if the network signals its support of the feature in the cell information by using a flag in one of the system information blocks (SIBs) or master information blocks (MIBs). An upgraded UE would then act on this indication which is acquired during the connection establishment (step 0). In such case the UE decides to use the feature, the UE includes the new IE carrying the UE FSI in the initial Attach message (step 1). This last embodiment has minor impact on RAN since it requires the eNBs to broadcast such additional information. The impact is however reasonable compared to that of introducing support of UP integrity protection in the RAN.

An embodiment is presented related to the security features and parameters that are negotiated for the CN terminated UP security. One possibility is that the UE FSI signals that the UE supports CN terminated UP security for both integrity and confidentiality protection in step 1. The procedure described in FIG. 4 would then result in the activation of both integrity and confidentiality protection for the user data between the UE and the S-GW. Observe that the MME includes the selected NAS confidentiality algorithm in step 5.

In order to remove the dependency between the selected NAS algorithms and the one used for the CN terminated UP security feature, one possibility is that the MME includes the selected algorithms for the feature in addition to all the other parameters in step 3. The MME would choose these additional algorithms from the list of supported algorithms indicated by the UE in the UE security capabilities IE. The MME would then signal the same selected algorithms to the S-GW in step 5.

An embodiment is presented related to the logical deployment of the function terminating the UP security in the CN. The function may be collocated with or realized by the S-GW. The function may be alternatively be realized by a standalone function as depicted in FIG. 3. However, such an alternative 3o requires defining new interfaces such as between the Authentication Management Field (AMF) and the UP-IP-F for the signalling of the security parameters.

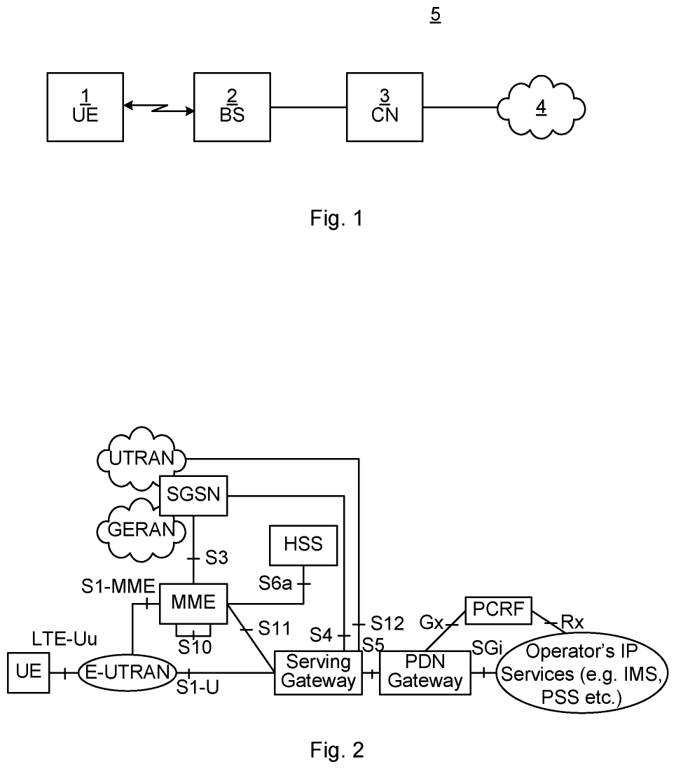

FIG. 1 is a schematic diagram illustrating an environment where embodiments presented herein can be applied. A UE 1 is in connectivity with a base station (BS) 2, in turn connected to a CN 3, all of a wireless communication system 5. The CN 3 may in turn be connected to Internet 4.

The UE 1 may e.g. be a user portable wireless device, mobile station, mobile phone, handset, wireless local loop phone, user equipment, smartphone, laptop computer, tablet computer, wireless modem, network equipped sensor, network equipped vehicle, wireless terminal (WT) and Internet-of-Things device. The BS 2 may e.g. be a radio access network node, radio base station, base transceiver station, backhaul network node, node B, evolved node B, g node B, access point, transmission and reception point.

It is to be noted that, while the embodiments presented herein are described as implemented using LTE (Long Term Evolution) any applicable communication standard may be used, such as any one or a combination of W-CDMA (Wideband Code Division Multiplex), LTE-SAE (Long Term Evolution-System Architecture Evolution), GSM (Global System for Mobile communication), EDGE (Enhanced Data Rates for GSM Evolution), GPRS (General Packet Radio Service), CDMA2000 (Code Division Multiple Access 2000), or any other current or future wireless network, such as LTE-Advanced or 5G NR (New Radio), as long as the principles described herein are applicable.

An embodiment of a method for user plane security in a wireless communication system is presented with reference to FIG. 6. The method is performed in a CN node 3 and comprises receiving S300 a first message from a WT, the first message including an indication that the WT 1 supports an additional security layer, sending S320 a second message to the WT in response to the received first message, the second message including an indication that the CN supports the additional security layer, and sending S330 a third message to a separate CN node, the third message comprising an indication that the additional security layer is to be used in communication with the WT.

The method may further comprise a step of determining S310 that the received additional security layer is supported by the CN.

The first message may be an initial attach message, the second message may be a NAS security mode command message, and the third message may be a create session request message.

The indication in the first message may be signalled by a spare bit in a security capability IE.

The CN node may be an MME, and the separate CN node may be an S-GW.

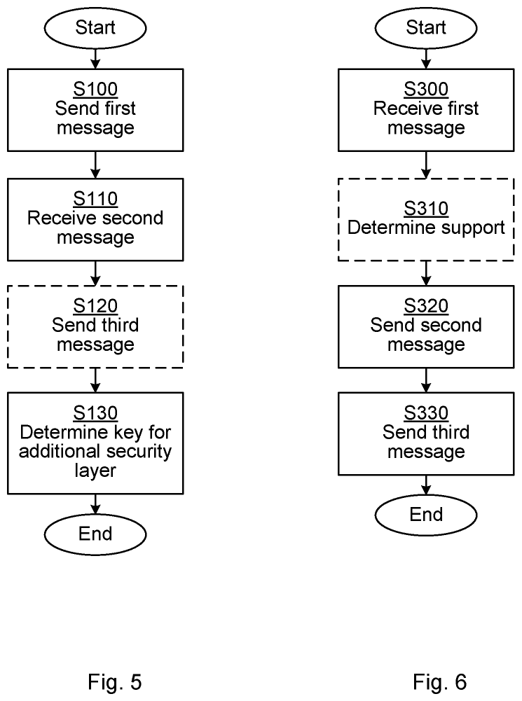

An embodiment of a method for user plane security in a wireless communication system is presented with reference to FIG. 5. The method is performed in a WT 1 and comprises sending S100 a first message to a CN node 3, the first message including an indication that the WT supports an additional security layer, receiving Silo a second message from the CN node in response to the send first message, the second message including an indication that the CN supports the additional security layer, and determining S130 an integrity protection key in response to the received second message, for use of the additional security layer in communication with a separate CN node.

The method may further comprise the step of sending S120 a third message to the CN node in response to the received second message, the third message being a NAS security mode complete message.

The first message may be an initial attach message, and the second message may be a NAS security mode complete message.

The indication in the first message may be signalled by a spare bit in a security capability IE.

The CN node may be an MME, and the separate CN node may be an S-GW.

An embodiment of a CN node for user plane security in a wireless communication system is presented with reference to FIG. 8. The CN node 3 comprises a processing circuitry 30 and a computer program product 32, 33 storing instructions 34, 35 that, when executed by the processing circuitry, causes the CN node to receive a first message from a WT, the first message including an indication that the WT 1 supports an additional security layer, send a second message to the WT in response to the received first message, the second message including an indication that the CN supports the additional security layer, and send a third message to a separate CN node, the third message comprising an indication that the additional security layer is to be used in communication with the WT.

The CN node may further be caused to determine that the received additional security layer is supported by the CN.

The first message may be an initial attach message, the second message may be a NAS security mode command message, and the third message may be a create session request message.

The indication in the first message may be signalled by a spare bit in a security capability IE.

The CN node may be an MME, and the separate CN node may be an S-GW.

FIG. 8 is a schematic diagram showing some components of the CN nose 3. The processing circuitry 30 may be provided using any combination of one or more of a suitable central processing unit, CPU, multiprocessing circuitry, microcontroller, digital signal processing circuitry, DSP, application specific integrated circuit etc., capable of executing software instructions of a computer program 34 stored in a memory. The memory can thus be considered to be or form part of the computer program product 32. The processing circuitry 30 may be configured to execute methods described herein with reference to FIG. 6.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 33 in the form of a data memory may also be provided, e.g. for reading and/or storing data during execution of software instructions in the processing circuitry 30. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 35, to improve functionality for the CN node 3.

The CN node 3 may further comprise an input/output (I/O) interface 31 including e.g. a user interface. The CN node 3 may further comprise a receiver configured to receive signalling from other nodes, and a transmitter configured to transmit signalling to other nodes (not illustrated). Other components of the CN node 3 are omitted in order not to obscure the concepts presented herein.

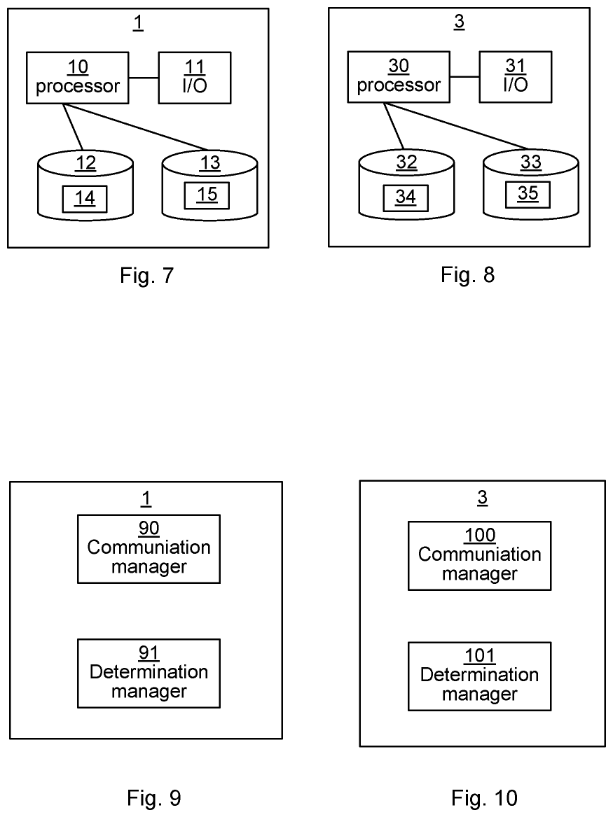

An embodiment of a WT for negotiation of security features in a wireless communication system is presented with reference to FIG. 7. The WT 1 comprises a processing circuitry 10 and a computer program product 12, 13 storing instructions 14, 15 that, when executed by the processing circuitry, causes the WT to send a first message to a CN node 3, the first message including an indication that the WT supports an additional security layer, receive a second message from the CN node in response to the send first message, the second message including an indication that the CN supports the additional security layer, and determine an integrity protection key in response to the received second message, for use of the additional security layer in communication with a separate CN node.

The WT may further be caused to send a third message to the CN node in response to the received second message, the third message being a NAS security mode complete message.

The first message may be an initial attach message, and the second message may be a NAS security mode command message.

The indication in the first message may be signalled by a spare bit in a security capability IE.

The CN node may be an MME, and the separate CN node may be an S-GW.

FIG. 7 is a schematic diagram showing some components of the WT 1. The processing circuitry 10 may be provided using any combination of one or more of a suitable central processing unit, CPU, multiprocessing circuitry, microcontroller, digital signal processing circuitry, DSP, application specific integrated circuit etc., capable of executing software instructions of a computer program 14 stored in a memory. The memory can thus be considered to be or form part of the computer program product 12. The processing circuitry 10 may be configured to execute methods described herein with reference to FIG. 5.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processing circuitry 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the WT 1.

The WT 1 may further comprise an input/output (I/O) interface ii including e.g. a user interface. The WT 1 may further comprise a receiver configured to receive signalling from other nodes, and a transmitter configured to transmit signalling to other nodes (not illustrated). Other components of the WT 1 are omitted in order not to obscure the concepts presented herein.

An embodiment of a CN node for negotiation of security features in a wireless communication system is presented with reference to FIG. 10. The CN node 3 comprises a communication manager 100 for receiving S300 a first message from a WT, the first message including an indication that the WT 1 supports an additional security layer, sending S320 a second message to the WT in response to the received first message, the second message including an indication that the CN supports the additional security layer, and for sending S330 a third message to a separate CN node, the third message comprising an indication that the additional security layer is to be used in communication with the WT.

FIG. 10 is a schematic diagram showing functional blocks of the CN node 3. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the method illustrated in FIG. 6, comprising a communication manager unit 100 and a determination manger unit 101. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manager 100 is for user plane security in a wireless communication system. This module corresponds to the steps S300, S320 and S330 of FIG. 6. This module can e.g. be implemented by the processing circuitry 30 of FIG. 8, when running the computer program.

The determination manger 101 is for user plane security in a wireless communication system. This module corresponds to the step S310 of FIG. 6. This module can e.g. be implemented by the processing circuitry 30 of FIG. 8, when running the computer program.

An embodiment of a WT for negotiation of security features in a wireless communication system is presented with reference to FIG. 9. The WT 1 comprises a communication manager 90 for receiving S300 a first message from a WT, the first message including an indication that the WT 1 supports an additional security layer, sending S320 a second message to the WT in response to the received first message, the second message including an indication that the CN supports the additional security layer, and for sending S330 a third message to a separate CN node, the third message comprising an indication that the additional security layer is to be used in communication with the WT.

FIG. 9 is a schematic diagram showing functional blocks of the WT 1. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the method illustrated in FIG. 5, comprising a communication manager unit 90 and a determination manger unit 91. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manager 90 is for user plane security in a wireless communication system. This module corresponds to the steps S100, Silo and S120 of FIG. 5. This module can e.g. be implemented by the processing circuitry 10 of FIG. 7, when running the computer program.

The determination manger 91 is for user plane security in a wireless communication system. This module corresponds to the step S120 of FIG. 5. This module can e.g. be implemented by the processing circuitry 10 of FIG. 7, when running the computer program.

An embodiment of a computer program 32, 33 for negotiation of security features in a wireless communication system is presented with reference to FIG. 8. The computer program comprises computer program code which, when run in a CN node, causes the CN node 3 to receive a first message from a WT, the first message including an indication that the WT 1 supports an additional security layer, send a second message to the WT in response to the received first message, the second message including an indication that the CN supports the additional security layer, and to send a third message to a separate CN node, the third message comprising an indication that the additional security layer is to be used in communication with the WT.

An embodiment of a computer program 12, 13 for negotiation of security features in a wireless communication system is presented with reference to FIG. 7. The computer program comprises computer program code which, when run in a WT, causes the WT 1 to send a first message to a CN node 3, the first message including an indication that the WT supports an additional security layer, receive a second message from the CN node in response to the send first message, the second message including an indication that the CN supports the additional security layer, and to determine an integrity protection key in response to the received second message, for use of the additional security layer in communication with a separate CN node.

A computer program product 12, 13, 32, 33 comprising a computer program 14, 15, 34, 35 and a computer readable storage means on which the computer program 14, 15, 34, 35 is stored is also presented.

The invention has mainly been described above with reference to a few embodiments. However, as is readily appreciated by a person skilled in the art, other embodiments than the ones disclosed above are equally possible within the scope of the invention, as defined by the appended patent claims.

1. A method for user plane security in a wireless communication system, the method being performed in a core network, CN, node and comprises:
receiving a first message from a wireless terminal, WT, the first message including an indication that the WT supports an additional security layer;
sending a second message to the WT in response to the received first message, the second message including an indication that the CN supports the additional security layer; and
sending a third message to a separate CN node, the third message comprising an indication that the additional security layer is to be used in communication with the WT.

2. The method according to claim 1, further comprising:
determining that the received additional security layer is supported by the CN.

3. The method according to claim 1, wherein the first message is an initial attach message, the second message is a non-access, NAS, security mode command message, and the third message is a create session request message.

4. The method according to claim 1, wherein the indication in the first message is signalled by a spare bit in a security capability information element, IE.

5. The method according to claim 1, wherein the CN node is a mobility management entity, MME, and the separate CN node is a serving gateway, S-GW.

6. A method for user plane security in a wireless communication system, the method being performed in a wireless terminal, WT, and comprises:
sending a first message to a core network, CN, node, the first message including an indication that the WT supports an additional security layer;
receiving a second message from the CN node in response to the send first message, the second message including an indication that the CN supports the additional security layer; and
determining an integrity protection key in response to the received second message, for use of the additional security layer in communication with a separate CN node.

7. The method according to claim 6, further comprising:
sending a third message to the CN node in response to the received second message, the third message being a non-access stratus, NAS, security mode complete message.

8. The method according to claim 6, wherein the first message is an initial attach message, and the second message is a NAS security mode command message.

9. The method according to claim 6, wherein the indication in the first message is signalled by a spare bit in a security capability information element, IE.

10. The method according to claim 6, wherein the CN node is a mobility management entity, MME, and the separate CN node is a serving gateway, S-GW.

11. A core network, CN, node for user plane security in a wireless communication system, the CN node comprising:
a processing circuitry; and
a computer program product storing instructions that, when executed by the processing circuitry, causes the CN node to:
receive a first message from a wireless terminal, WT, the first message including an indication that the WT supports an additional security layer;
send a second message to the WT in response to the received first message, the second message including an indication that the CN supports the additional security layer; and
send a third message to a separate CN node, the third message comprising an indication that the additional security layer is to be used in communication with the WT.

12. The CN node according to claim 11, further caused to:
determine that the received additional security layer is supported by the CN.

13. The CN node according to claim 11, wherein the first message is an initial attach message, the second message is a non-access, NAS, security mode command message, and the third message is a create session request message.

14. The CN node according to claim 11, wherein the indication in the first message is signalled by a spare bit in a security capability information element, IE.

15. The CN node according to claim 11, wherein the CN node is a mobility management entity, MME, and the separate CN node is a serving gateway, S-GW.

16. A wireless terminal, WT, for user plane security in a wireless communication system, the WT comprising:
a processing circuitry; and
a computer program product storing instructions that, when executed by the processing circuitry, causes the WT to:
send a first message to a core network, CN, node, the first message including an indication that the WT supports an additional security layer;
receive a second message from the CN node in response to the send first message, the second message including an indication that the CN supports the additional security layer; and
determine an integrity protection key in response to the received second message, for use of the additional security layer in communication with a separate CN node.

17. The WT according to claim 16, further caused to:
send a third message to the CN node in response to the received second message, the third message being a non-access stratus, NAS, security mode complete message.

18. The WT according to claim 16, wherein the first message is an initial attach message, and the second message is a NAS security mode command message.

19. The WT according to claim 16, wherein the indication in the first message is signalled by a spare bit in a security capability information element, IE.

20. The WT according to claim 16, wherein the CN node is a mobility management entity, MME, and the separate CN node is a serving gateway, S-GW.

21.-25. (canceled)
